(19) United States
(12) Patent Application Publication
(10) Pub. No.: US 2026/0100639 A1
(43) Pub. Date: Apr. 9, 2026

(54) FAST SURGE-OVERVOLTAGE PROTECTION TUNABLE CIRCUIT

(71) Applicant: BorgWarner Inc., Auburn Hills, MI (US)

(72) Inventor: Luca Di Carlo, Royal Oak, MI (US)

(21) Appl. No.: 18/906,195

(22) Filed: Oct. 4, 2024

(51) Int. Cl. H02M 1/32; H02M 3/335

(52) U.S. Cl. CPC H02M 1/32; H02M 3/33576

(57) ABSTRACT

A power conversion apparatus includes an input stage to receive an alternating current (AC) voltage and having a plurality of switches, a sensing circuit coupled to a monitored node in the input stage and configured to assert a disable signal when a sensed voltage level indicative of an overvoltage condition, exceeds a selectable threshold voltage level, the sensing circuit including a latch to maintain the disable signal until a release event occurs, such as after the overvoltage condition subsides or a predetermined time has elapsed, and a controller configured to control the switches into conductive and non-conductive states for power conversion where the controller is further configured to place the switches into non-conductive states in response to and while the disable signal is asserted.

### TECHNICAL FIELD

The present application relates generally to power conversion devices and more particularly to overvoltage protection for power conversion devices.

### BACKGROUND

An overvoltage condition can occur in a power conversion device of the type containing power switching devices, hereinafter sometimes referred to as switches. Such an overvoltage condition can be caused by a surge in the grid supplying input alternating current (AC) power to the conversion device or by an internal issue in the conversion device itself. Such an overvoltage condition, if not taken into account during the design of the conversion device, can damage one or more of the switches.

Such a conversion device may include an additional discrete component for protection purposes, such as a transient voltage suppression device, surge protection device, or a varistor. However, such additional components may become less reliable over time due to the relatively rapid aging of such discrete components. Moreover, an additional component may increase cost.

Therefore, it would be desirable for a more reliable and cost-efficient approach for protecting switches in a power conversion device.

### SUMMARY

In one embodiment, a power conversion apparatus is provided that includes an input stage, a sensing circuit, and an electronic controller. The input stage has an input configured to be connected to receive an alternating current (AC) voltage or in alternate implementations a direct current (DC) voltage (e.g., a DC microgrid), and includes a plurality of switches electrically coupled to the input and arranged in accordance with a power conversion topology. The sensing circuit is coupled to a monitored node in the input stage and is configured to assert a disable signal when a sensed voltage level, corresponding to a node voltage level at the monitored node, exceeds a selectable threshold voltage level indicative of an overvoltage condition. The sensing circuit further includes a latch configured to maintain the assertion of the disable signal until a release event occurs. In embodiments, the threshold voltage level is selectable and the release event may occur in response to a detection of when the overvoltage condition has subsided or after a predetermined time has elapsed. The controller is configured to control the plurality of switches into conductive and non-conductive states for power conversion in accordance with a predetermined power conversion strategy. The controller is further configured to control the plurality of switches into respective non-conductive states in response to and while the disable signal is asserted.

In another embodiment, a method of protecting switches in a power conversion apparatus from an overvoltage event includes controlling a plurality of switches in an input stage of the power conversion apparatus into conductive and non-conductive states for power conversion according to a predetermined power conversion strategy. The method further includes sensing at least one voltage level corresponding to a node voltage level on at least one node in the input stage, determining when the sensed at least one voltage level exceeds a threshold voltage level indicative of an overvoltage condition on the at least one node and asserting a disable signal, and rendering the plurality of switches into non-conductive states in response to and while the disable signal is asserted.

The foregoing and other aspects, features, details, utilities, and advantages of the present disclosure will be apparent from reading the following description and claims, and from reviewing the accompanying drawings.

### BRIEF DESCRIPTION OF THE DRAWINGS

FIG. 1 is a block diagram depicting an embodiment of a power conversion apparatus;

FIG. 2 is a circuit diagram depicting an embodiment of a power conversion apparatus including a front level power factor correction (PFC) circuit;

FIG. 3 is a circuit diagram depicting a sensing circuit, in an implementation;

FIGS. 4A-4B are timing diagrams depicting an exemplary input voltage surge (overvoltage) and a disable signal, respectively;

FIG. 5 is a block diagram depicting an embodiment of a timer whose output is used as a latch release;

FIG. 6A is a block diagram depicting an embodiment of a digital-to-analog (DAC) circuit outputting a threshold signal selectable based on an input digital value;

FIG. 6B is a simplified schematic diagram depicting an analog circuit configured to generate a threshold signal selectable based on which one of a plurality of gate inputs has an activation signal applied thereto;

FIG. 7 is a circuit diagram depicting an embodiment of a matrix converter and a control system; and

FIG. 8 is a flowchart diagram depicting an embodiment of a method of protecting switches, in a power conversion apparatus, from an overvoltage event.

### DETAILED DESCRIPTION

An electrical power conversion apparatus may be positioned between a source of alternating current (AC) voltage such as the electrical grid (or DC microgrid) and a direct current (DC) load, such as a stationary electric vehicle battery charger, but can be subject to power surges. These power surges may be from an external source, such as the electrical grid, or an internal source, such as from a battery or other power source. During the operation of the conversion apparatus, a plurality of switches, such as MOSFETs, are rendered conductive and non-conductive as part of the rectifying of the input AC voltage. However, when such a power surge occurs, an overvoltage condition appearing on one or more nodes in the conversion apparatus can affect the switches differently depending on whether the particular switch is in a conductive or a non-conductive state.

Before proceeding to a detailed description, a general overview will be set forth. One object is to provide protection to power switches in an electrical power conversion apparatus when an overvoltage condition occurs (e.g., internally to the apparatus) or when a surge event occurs on the input electrical grid. In embodiments, functionality is provided to measure voltage levels at desired points (nodes) at or over some part of the conversion apparatus and determine when the measured voltage level is above a programmable (selectable) threshold level, and then render the switches therein non-conductive. The threshold voltage level may, in embodiments, be selectable (e.g., programmable) so as to provide the ability to tune or adapt the protection to different conditions, for example, a power supply that can work at 120V or 230V or a battery charger that can charge from 200V to 500V. In embodiments, the protection may involve latching the switches in the non-conductive state while the measured voltage level is above the selectable threshold voltage level or for some defined amount of time. As described hereinafter, rendering the switches into a non-conductive state results in the undesired overvoltage (i.e., potentially harmful to one or more of the switches) being spread across or split between two and possibly more of the switches depending on the topology used. In other words, the overvoltage will be split into two or more parts reducing the magnitude of the overvoltage borne by each of the switches.

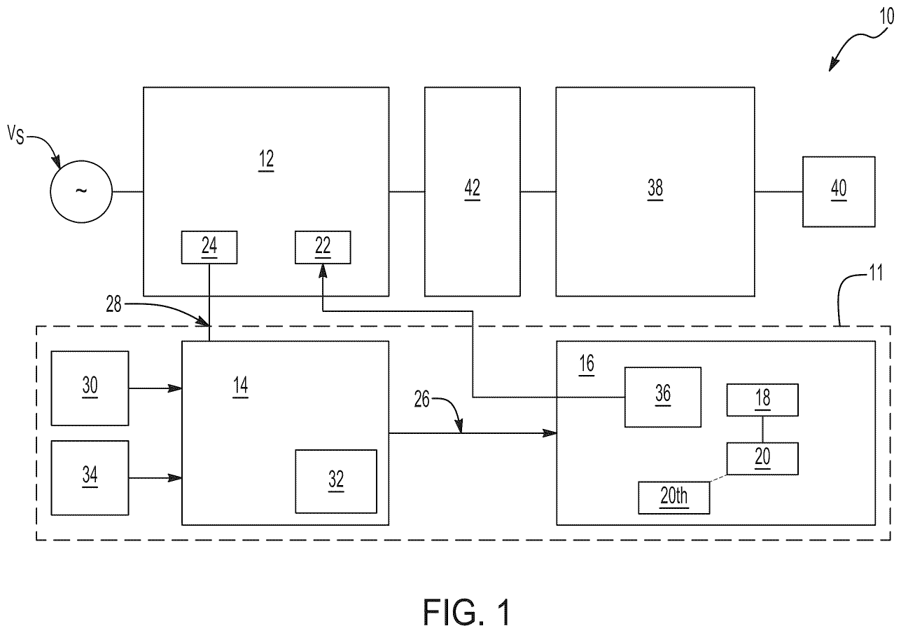

Referring now to the drawings wherein like reference numerals are used to identify identical or similar components in the various views, FIG. 1 is a block diagram of a power conversion apparatus 10 configured for protecting power switching devices included therein. Apparatus 10 includes a control system 11 (enclosed in dashed line format) configured generally to implement a desired control strategy for the operation of the conversion apparatus 10.

Conversion apparatus 10 further includes an input stage 12 wherein control system 11 includes a sensing circuit 14 and an electronic controller 16. Input stage 12 configured to be connected to receive an alternating current (AC) voltage from an input AC voltage source Vs, for example, from the electrical grid or other power source. Input stage 12 further includes a plurality of switches 22, illustrated in block form, which are electrically coupled to input source Vs and are further arranged in accordance with a selected power conversion topology selected based on, for example, an intended use. For example only, intended uses may include use of the conversion apparatus as a DC power supply, as an electrical vehicle charger such as a DC fast charger, and other uses now known or hereafter developed. Depending on the use, a wide variety of power conversion topologies may be employed, as also known. Input stage 12 further includes one or more monitored nodes, shown in block form as monitored node(s) 24.

Sensing circuit 14 is coupled to monitored node(s) 24 and is configured to sense a voltage level (sensed voltage level) that corresponds to a node voltage level 28 present at the monitored node(s) 24. Sensing circuit 14 is further configured to assert a disable signal 26 when the sensed voltage level exceeds a selectable threshold voltage level 30, which may be programmable in certain embodiments. The threshold voltage level 30 may be established so as to be indicative of a power surge or an overvoltage condition at the monitored node(s) 24. The controller 16, in response to the asserted disable signal 26, places the switches in a non-conductive state, as described below. The sensing circuit 14 further includes a latch 32 configured to maintain the disable signal 26 in its asserted state (once asserted) until a release event 34 resets the latch effect to thereby de-assert the disable signal 26 and allow the controller 16 to resume normal operation.

Controller 16 includes an electronic processor 18 and a memory 20. Processor 18 includes processing capabilities as well as an input/output (I/O) interface through which the processor 18 may receive various input signals and generate a plurality of output signals (e.g., gate drive signals from gate drive logic block 36). Memory 20 is provided for storage of data as well as instructions or code (i.e., software) for processor 18. Memory 20 may include various forms of non-transitory memory and may include non-volatile memory for storing and accessing computer-readable instructions executable by processor 18 as well as programmable memory configured to store, for example, memory 20_{TH} configured to store a digital value corresponding to the selectable (programmable) threshold voltage level 30, in an embodiment.

Controller 16, in normal operation, is configured to control the plurality of switches 22 into conductive and non-conductive states for power conversion, for example, rectifying the input AC voltage from source Vs to a DC voltage, in accordance with a power conversion strategy. The art discloses numerous examples of applicable power conversion strategies. Controller 16 is further configured to control the plurality of switches 22 into non-conductive states in response to and while the disable signal 26 is asserted.

Processor 16 executes gate drive logic 36 to produce gate drive signals, which may be provided to gate drive circuitry (not shown) to be electrically communicated to the respective gates of each of the plurality of switches 22 to control a respective conductivity state (i.e., conductive or ON and non-conductive or OFF). The operating control established by controller 16 as well as the other features described herein may be implemented as computer-readable instructions executable by the processor 18 stored in memory 20 and called on to control the functionality of apparatus 10 in accordance with a selected power conversion strategy.

With further references to FIG. 1, embodiments may include an output stage 38 configured to output a direct current (DC) voltage 40 on an output thereof. Input and output stages 12, 38 may be inductively coupled (but electrically isolated) by way of a transformer 42, where a primary winding of transformer 42 may form a part of input stage 12 and a secondary winding of transformer 42 may form a part of output stage 38.

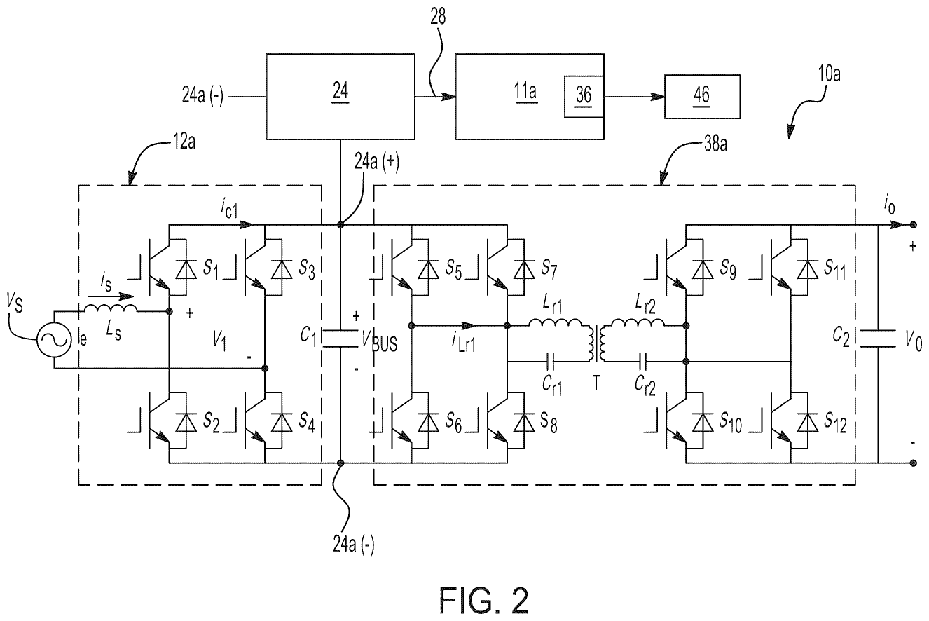

FIG. 2 is a circuit and block diagram of an embodiment of a power conversion apparatus 10a. The apparatus 10a overall comprises an AC/DC converter and includes an input stage, designated 12a, which is a front level totem pole bridgeless power factor correction (PFC) stage (or circuit) configured for AC/DC conversion and an output stage, designated 38a, which is a post stage CLLC resonant converter configured for DC/DC conversion. The input stage 12a of the apparatus 10a is electrically connected to an AC source Vs (e.g., the grid—a source voltage Vₛ supplying a source current iₛ). The output stage 38a of the apparatus 10a is configured to produce an output voltage vₒ and output current iₒ.

The input stage 12a is a single-phase totem pole PFC and includes an input source inductor Lₛ and switches S₁, S₂, S₃, and S₄. Switches S₁ and S₂ are connected in series at a first intermediate node (i.e., the emitter of S₁ being connected to the collector of S₂ at the first intermediate node). Switches S₃ and S₄ are also connected in series at a second intermediate node (i.e., the emitter of S₃ being connected to the collector of S₄ at the second intermediate node). The inductor Lₛ is connected between a positive lead of the source Vs and the first intermediate node while the negative lead of the source Vs is connected to the second intermediate node. The voltage across the first and second intermediate nodes is designated v₁ in FIG. 2.

Between the input stage 12a and the output stage 38a, the apparatus 10a includes a capacitor C₁ across which is defined a DC bus that comprises a V_{bus}(+) identified by node 24a(+) and V_{bus}(−) identified by node 24a(−).

The output stage 38a includes switches S₅-S₁₂, a transformer T having a primary winding and a secondary winding, a first resonant inductor Lᵣ₁ and a first resonant capacitor Cᵣ₁ both coupled in series with the primary winding, and a second resonant inductor Lᵣ₂ and a second resonant capacitor Cᵣ₂ both coupled in series with the secondary winding. The following switch pairs are series-connected: switches S₅, S₆; switches S₇, S₈; switches S₉, S₁₀; and switches S₁₁, S₁₂. The output stage 38a also includes an output capacitor C₂ across which the output voltage vₒ is defined.

FIG. 2 further shows a control system 11a configured to manage the operation (i.e., manage the conduction and non-conduction) of switches S₁-S₄ of the input stage 12a and switches S₅-S₁₂ of the output stage 38a, using gate drive logic 36, by producing a plurality of gate drive signals 46 for the switches S₁-S₁₂. The control system 11a may employ a PFC energy conversion strategy known in the art for controlling the switches S₁-S₄ in such a way so as to control the instantaneous current drawn from the AC source Vs so as to be in phase to an extent possible with the instantaneous voltage of the AC source Vs (i.e., power factor correction (PFC)). The PFC conversion strategy may be stored as instructions in memory 20 to be executed by the processor 18 (FIG. 1). In this regard, switches S₃-S₄ may be operated at a grid line frequency while switches S₁-S₂ may be operated at a relatively high frequency so that, overall, energy is selectively stored in inductor Lₛ at certain times and selectively released to the DC bus capacitor C₁ at certain other times according to a variety of inputs (e.g., load requirements). The art is replete with control methods for operating input stage 12a in such a fashion and accordingly, for the sake of brevity, no further detail will be set forth.

The output stage 38a is a post stage CLLC resonant DC/DC converter with the DC bus (nodes 24(+) and 24(−)), switches S₅-S₈, and resonant inductor/capacitor L_{R1}, C_{R1} on the primary side of the transformer T and resonant inductor/capacitor L_{R2}, C_{R2}, switches S₉-S₁₂, and output capacitor C₂ (DC output vₒ) on the secondary side of the transformer T. The control system 11a may employ a post stage conversion strategy known in the art for controlling the switches S₅-S₁₂. The post stage conversion strategy may be stored as instructions in memory 20 to be executed by processor 18 (FIG. 1). The art is replete with control methods for operating the post stage 38a and accordingly, for the sake of brevity, no further detail will be set forth.

With continued reference to FIG. 2, if a grid surge event occurs to the working (i.e., in operation) power conversion apparatus 10a, but without the protection features of the instant disclosure, the surge would be applied not to all the switches in the configuration but to just a few of them. If a positive surge event happens on the phases of AC source Vs, the positive pulse will injected into the system bus Vbus(+) at node 24a(+). Furthermore, if any the switches S₅-S₈ is conducting at the time of the surge, the voltage drop across the ON (i.e., conductive state) switch will be its resistance multiplied by the electrical current therethrough—perhaps a few volts. Substantially all of the surge voltage would then be applied directly across the nonconductive one or more switches, with only a small voltage drop across the conducting switches. In such a case, the magnitude of the overvoltage may harm the non-conducting switches.

However, according to teachings of the instant disclosure as embodied in the control system 11a shown in FIG. 2, all of the switches S₅-S₈ are switched OFF, as well as switches S₁-S₄, and thus the overvoltage caused by the power surge will be split into or divided across two parts in the illustrated embodiment, namely, across switches S₅, S₆ and S₇, S₈ (and switches S₁, S₂ and S₃, S₄ of the input stage). In an implementation, all the switches in the apparatus 10a are switched OFF in the event that a surge or overvoltage event is detected. Additionally, depending on the polarity of the surge, it will pass through the body diode of one or two of the switches of the PFC.

The sensing circuit 14 (FIG. 1) coupled to nodes V1(+) and V1(−) and nodes 24a(+), 24a(−) detects the overvoltage and will assert (i.e., activate) the disable signal 26 wherein the controller 16, in response to and while the disable signal 26 continues to be asserted, controls the switches into non-conductive states. Thus, a first part of the overvoltage will drop across one of the series-connected switches and a second part of the overvoltage will drop across the other one of the series-connected switches. As an example, absent the present teachings, if a two-kilovolt surge were applied directly to power conversion apparatus 10a while apparatus 10a was in operation, the OFF (non-conducting) switch would “see” substantially all of the overvoltage. However, embodiments consistent with the instant teachings are configured to detect the overvoltage wherein both switches are controlled OFF and then each of the switches would “see” just circa half of the surge overvoltage. More generally, the overvoltage may be split into two or more parts, depending on the particular topology being used in a power conversion apparatus.

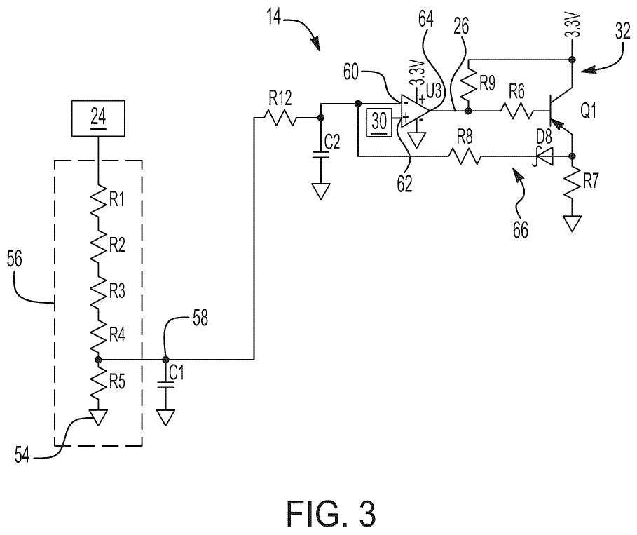

FIG. 3 is a circuit diagram showing in greater detail the sensing circuit 14 of FIG. 1, in an implementation. In the illustrative embodiment, the sensing circuit 14 includes a resistive voltage divider 56 electrically coupled between the monitored node 24 (e.g., DC bus) and a reference node, which may be a ground node 54 as shown. Voltage divider 56 is configured to produce a sensed signal 58 having a sensed voltage level that corresponds to but is scaled down relative to the node voltage on the monitored node 24. It should be appreciated that during power surges, voltage levels in the kilovolt range may be present on the monitored node wherein the usefulness of a voltage divider to produce a corresponding sensed voltage signal 58 becomes apparent.

The sensing circuit 14 further includes a comparator U3 that includes (i) an inverting input 60 coupled to receive sensed signal 58 via resistor R12, (ii) a non-inverting input 62 configured to receive a threshold signal having the selectable threshold voltage level 30, and (iii) an output 64 configured to produce disable signal 26, which is produced in an asserted state by comparator U3 when a sensed voltage level of the sensed signal 58 exceeds the selectable threshold voltage level 30. The latch 32 of the sensing circuit 14 further includes a feedback circuit 66 including resistors R6, R7, R8, R9, transistor Q1, and diode D8. In an embodiment, the components of the sensing circuit 14 may comprise commercially available components having values or meet performance criteria suitable for the intended application. It should be understood, however, that while the sensing circuit 14 of FIG. 3 comprises a hardware-centric realization, other variations are contemplated. For example only, the latch functionality may be implemented as a software-centric realization in the controller 16 (e.g., software stored in memory 20 and executed by the processor 18), and/or a combination of hardware and software.

In operation, while the DC bus/monitored node 24 is within normal operating range, the selectable threshold voltage level 30 at the non-inverting input 62 remains higher than that of the sensed signal 58 at the inverting input 60 and thus the comparator output will be high. However, once an overvoltage condition occurs, the sensed voltage 58 will be higher than the selectable threshold causing the output of the comparator U3 to go low. This causes the transistor to conduct, pulling up high the node at the connection of emitter terminal (of Q1) and resistor R7, which signal is now applied to the inverting input 60 via a component path comprising diode D8 and resistor R8. Disable signal 26 is active low (asserted) and when it is high it is considered de-asserted. Latch 32 keeps disable signal 26 asserted until a release event occurs, which means the plurality of switches 22 (e.g., switches S₁-S₁₂ in FIG. 2) are controlled to an OFF state (non-conductive state) by controller 16 in response to and while the disable signal 26 is asserted. The selectability of threshold level 30 and the release event(s) 34 will be described in greater detail below.

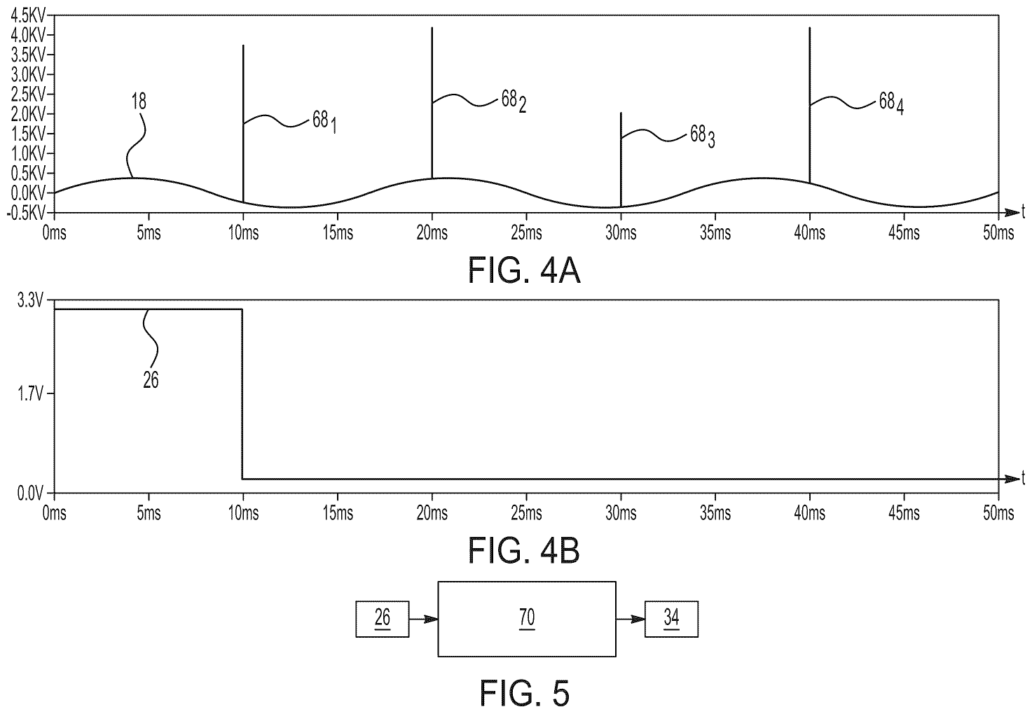

FIGS. 4A-4B are timing diagrams illustrating AC input source Vs and the states of the disable signal 26 both along a common timeline. The sensing circuit 14 may be configured to supervise multiple voltages at the same time, for example, the three phases of a 3-phase AC input source Vs and the resulting post-rectification DC Bus (node 24), using a properly selected voltage divider.

FIG. 4A, between time t=0s and just before time t=10 milliseconds, depicts the AC input voltage source Vs as an expected sinusoid having a magnitude in a normal operating range (e.g., as shown roughly±480 vac). Accordingly, FIG. 4B shows disable signal 26 in a de-asserted state (high). At roughly time t=10 milliseconds, however, a first overvoltage event 68₁ occurs wherein the sensing circuit 14 responds by asserting the disable signal 26, which is now shown in the low state. The controller 16 is configured to control the plurality of switches into a non-conductive state (OFF) in response to and while the disable signal 26 remains asserted. Latch 32 is operative to keep the disable signal 26 asserted even after the overvoltage 68₁ has subsided. Thus, in the illustrated implementation, a high signal 26 means that no overvoltage and/or surge fault has been detected while a low signal 26 means that an overvoltage and/or surge fault has been detected.

FIG. 4A further shows second, third, and fourth overvoltage events 68₂, 68₃, and 68₄ occurring at roughly times t=20 milliseconds, t=30 milliseconds, and t=40 milliseconds, respectively. Note that the latch 32 keeps the disable signal 26 asserted even though the AC input voltage Vs returns to within normal operating range a number of times, except for the multiple subsequent re-occurrences of overvoltage events 68₂, 68₃, and 68₄. As a consequence of the disable signal 26 being held in the asserted state, the controller 16 will keep the switches in the non-conductive states (OFF).

The latching feature that holds the power switches in a non-conductive state until a release event occurs and the selectable voltage threshold 30 (i.e., programmable in some embodiments) will now be described in greater detail.

FIG. 5 is a block diagram depicting an embodiment of a timer 70 configured to generate an output that can function as a latch release event 34. The timer 70 is configured to output a signal after a predetermined time has elapsed as taken from the time the disable signal 26 was asserted (i.e., after the onset of the overvoltage condition). The latch release event 34 (i.e., the timer output) is provided to the sensing circuit 14, which releases the latch that was acting on the signal 26, thereby de-asserting the signal 26.

In embodiments, the controller 16 may be configured to generate the latch release event 34 upon determining that the overvoltage event or condition has ended or also, like the timer 70, after a predetermined time has elapsed since the beginning of the overvoltage condition, or other predetermined criteria. It should be understood that there is a delay and latch because the system could be subjected to several reoccurring overvoltage and/or surge events. In an implementation, one strategy involves the latch maintaining the disable signal 26 in an asserted state (fault condition) for half a period of the AC grid sinewave. For an implementation involving a 60 Hz line frequency electrical grid, a half a period is about eight and one-third milliseconds.

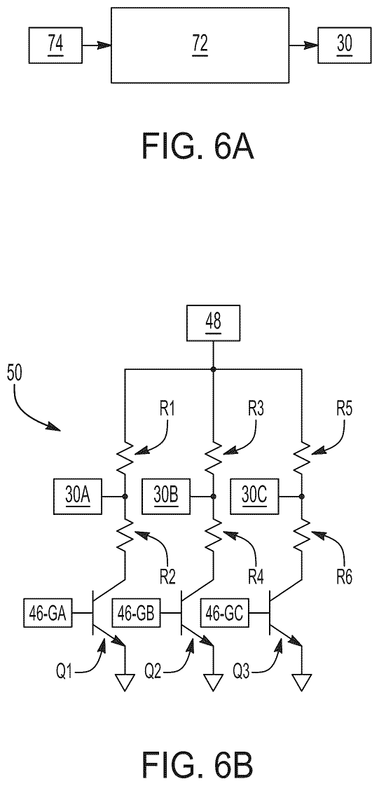

FIG. 6A is a block diagram depicting an embodiment of a digital-to-analog converter (DAC) circuit outputting the threshold voltage level 30 described above. The threshold voltage level 30 is, in embodiments, selectable based on a selectable digital value 74 input thereto. The particular value of the selectable (i.e., programmable) threshold voltage level 30 may be established by storing a corresponding digital value in memory 20ₜₕ (memory 20ₜₕ best shown in FIG. 1) which can then be retrieved, applied to the DAC 72 to generate the threshold voltage level 30. By configuring the threshold voltage level 30 so as to be selectable may be useful in embodiments where the same power conversion apparatus (or portions thereof) can or will be used in different conditions. Such different conditions may include use as a power supply that can work at input voltages of 120V or 230V or use as a battery charger that can charge a battery from 200 V to 1000V. The selectable threshold voltage level 30 can therefore be dynamically generated by the DAC 72 according to the power conversion apparatus 10's specific needs/requirements. In an implementation, the DAC 72 comprises a functional block internal to the controller 16.

FIG. 6B is a simplified schematic diagram of an analog circuit 50 configured to output one of a plurality of threshold voltage levels. In an implementation, the circuit 50 may be used in place of the DAC circuit 72 described above. The circuit 50 includes a first resistive voltage divider comprising resistors R1, R2, a second resistive voltage divider comprising resistors R3, R4, and a third resistive voltage divider comprising resistors R5, R6. The circuit 50 further includes transistor switches Q1, Q2, and Q3 connected in series with a respective one of the first, second, and third resistive voltage dividers. In an implementation, the transistor switches Q1, Q2, and Q3 may comprises NPN type transistors. The first, second, and third resistive voltage dividers of the circuit 50 are coupled to a suitable voltage signal source 48. The circuit 50 is operative to output one of three different threshold voltage levels 30A, 30B, and 30C based on activating a corresponding one of the gate signals 46-GA, 46-GB, and 46-GC. The gate signals 46-GA, 46-GB, and 46-GC may be activated and deactivated by the controller 16.

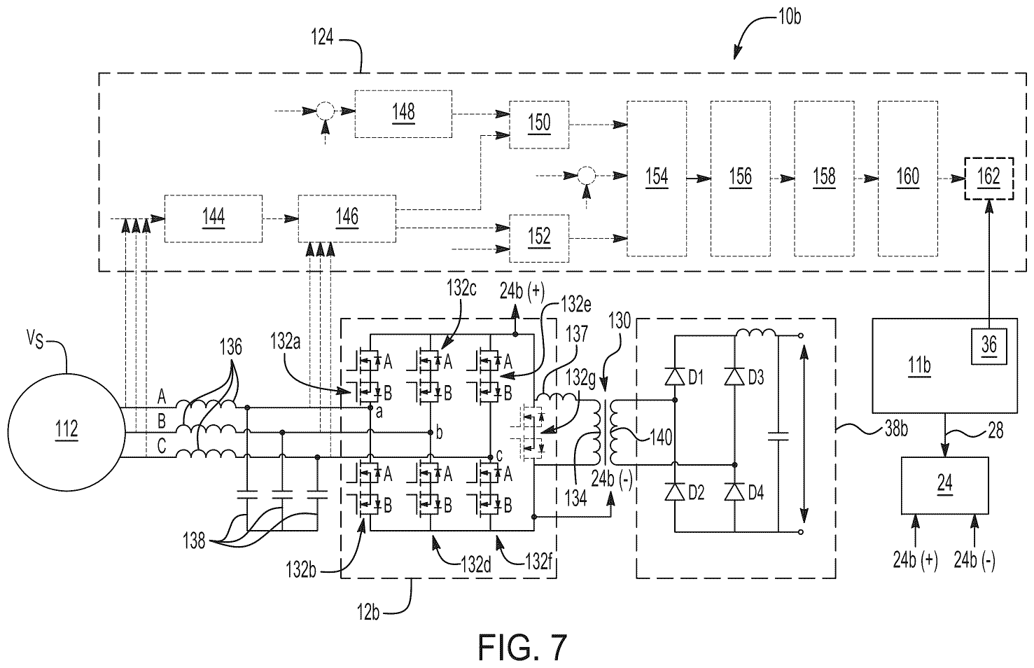

FIG. 7 is a circuit diagram depicting a DC fast charger embodiment of a power conversion apparatus that is designated apparatus 10b. The teachings of the instant disclosure can thus be applied to more complex systems, such as this DC fast charger 10b, which includes an indirect, isolated matrix converter and accompanying control system. Functionally, such a DC fast charger may receive, for example, a 480VAC input from the grid 112 and have a power rating of 60-360 kW available for being provided to an electric vehicle (EV—not shown). This type of DC fast charging may be referred to as Level 3 EV charging. The illustrated implementation is a seven-switch indirect matrix converter DC fast charger suitable for vehicular applications and is unidirectional such that it converts electric power received from a grid and supplies the converted power to an electric vehicle to charge the vehicle (G2V).

Apparatus 10b includes an input stage comprising a primary circuit 12b having a seven-switch topology including switches that are bidirectional, and an output stage comprising a secondary circuit 38b that can use a passive diode bridge rather than actively-controlled switches, such as those having a gate that regulates conductivity, thereby reducing cost relative to other designs. Primary circuit 12b and secondary circuit 38b are inductively coupled together via a transformer 130. The electrical power supplied to apparatus 10b is three-phase AC electrical power from the grid 112.

The primary circuit 12b includes seven switches 132a-g that are electrically coupled to the grid 112 and a primary winding 134 of the transformer 130. The switches 132a-g can be implemented using bipolar junction transistors (BJTs) or field effect transistors (FETs), such as insulated gate bipolar transistors (IGBTs), metal-oxide-semiconductor field effect transistors (MOSFETs), gallium nitride transistors (GaN) or silicon carbide (SiC) transistors. Switches 132a-g can be bidirectional or reverse-blocking such that they are four-quadrant switches capable of conducting positive or negative on-state current and blocking positive or negative off-state voltage. A number of different circuit configurations can be used to implement such a switch any of which could be implemented in the DC fast charger described herein. In one implementation, each switch 132a-g includes an A side MOSFET and a B side MOSFET with gates that can be electrically connected to a microprocessor (i.e., controller 16 with processor 18). Six switches 132a-f can be electrically coupled to three legs of the electrical grid PHA, PHB, PHC and nodes a, b, c of the primary circuit 12b. Voltages of these three legs can be identified as Vₐ, V_{b}, and V_{c}. A seventh switch 132g can be wired in parallel with switches 132e and 132f, and with the primary winding 134 of the transformer 130. Inductors 136 and bulk capacitance 138 can be electrically connected to the legs PHA, PHB, PHC of the grid 112.

The secondary circuit 38b is electrically connected to a secondary winding 140 of the transformer 130 and includes a passive full-bridge rectifier that can be implemented using four diodes D1-D4. The diodes in the secondary circuit 38b can be implemented using any one of a variety of different types of diodes. The secondary circuit 38b can include an electrical filter with an inductor and a capacitor that smooths the output DC voltage. An EV battery (not shown) can be electrically connected to the diodes such that the secondary circuit 38b passively rectifies AC voltage induced through the secondary winding 140 into DC voltage applied to the EV battery.

Apparatus 10b includes a first control system 124 that is responsive to various input signals and is configured to generate gate signals at block 162 to be electrically communicated to the gates of the switches 132 to control the switches 132 into conductive and non-conductive states for power conversion in accordance with a predetermined power conversion strategy. An exemplary approach will be set forth below and may be seen by reference to U.S. application Ser. No. 18/226,389, filed 26 Jul. 2023, which is hereby incorporated by reference as though fully set forth herein. Apparatus 10b further includes a second control system 11b configured to control switches 132a-f into non-conductive states when an overvoltage condition is detected as described herein, and in a further feature, control switch 132g into a conductive state when such an overvoltage condition is detected, to be described hereinafter. It should be understood that the illustration of first and second control systems 124, 11b is for description purposes only and does not necessarily mean that such controls systems are separate and distinct and can be consolidated in embodiments.

In operation, control system 124 controls the plurality of switches 132a-g into conductive and non-conductive states for power conversion according to a predetermined power conversion strategy. The sensing circuit 14 (part of control system 11b) monitors voltage levels across a desired portion of apparatus 10b across switch 132g by way of monitored nodes 24b(+) and 24b(−), resulting in a sensed voltage level. The sensing circuit 14 determines when the sensed voltage level exceeds the threshold voltage level 30 indicative of an overvoltage condition wherein the sensing circuit 14 asserts the disable signal 26. The overvoltage event can be caused by a surge from the grid 112 or by an internal issue possibly caused by electromagnetic noise.

Detection of the overvoltage event triggers two protection mechanisms. The first protection mechanism is where the controller 16 (part of control system 11b) renders the plurality of switches 132a-f into non-conductive states in response to and while the disable signal 26 is asserted. Thus, switches 132a-f are latched OFF until released as described herein. The second protection mechanism involves the controller 16 rendering switch 132g into a conductive (ON) state. This second mechanism will allow current circulating in inductor 137 and transformer 130 to dissipate in the switch 132g, which can be designed to survive a system-specific pulse current and at the same time clamp the overvoltage to a level that is safe for the remainder of the apparatus. In sum, the switch 132g is latched ON while the rest of the matrix is turned OFF when an overvoltage event is detected, as this will allow the overvoltage to be split into two parts of each matrix half bridge as well as the dissipation of current flowing in the transformer (and inductor) in the switch 132g.

Through the first mechanism, the apparatus is capable of dissipating overvoltage events directly applied to switches 132a-f in a repetitive way, and through the second mechanism, namely, the concurrent activation of the switch 132g, limiting a portion of the overvoltage peak through dissipative action—keeping it in an acceptable range. The foregoing approach can be extended to grid generated surge events.

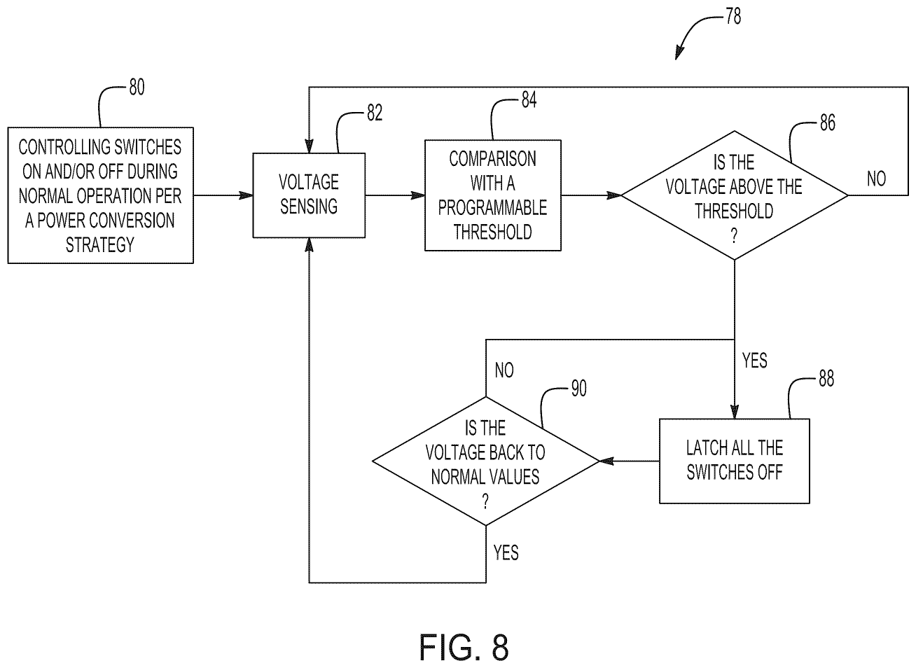

FIG. 8 is a flowchart diagram depicting an embodiment of a method of protecting switches in a power conversion apparatus from an overvoltage event. The method begins in step 80 with controlling a plurality of switches in an input stage of the power conversion apparatus into conductive (ON) and non-conductive (OFF) states as per a predetermined power conversion strategy. The method proceeds to step 82.

Step 82 involves sensing at least one voltage level across a portion of interest in the input stage, such as between a monitored node and a reference node. The method proceeds to step 84.

Step 84 involves determining when an overvoltage event has occurred and/or exists by a comparison of the at least one sensed voltage level with a selectable threshold voltage level. The method proceeds to step 86.

Step 86 involves determining whether (or when) the sensed voltage level exceeds or is above the selectable threshold voltage level. If the answer is NO, then the method branches back to step 82 (constantly sensing the voltage at the monitored node). If the answer is YES, however, then the method branches to step 88.

Step 88 involves asserting and latching the disable signal, which in turn latches the plurality of switches into a non-conductive state. The method proceeds to step 90.

Step 90 involves determining when a latch release event has occurred. This step may involve determining the time when the voltage across the monitored portion of the input stage has returned to normal values (i.e., the overvoltage or power surge has subsided). This step may also involve determining when a predetermined amount of time has passed since the overvoltage event was first detected. If the answer in step 90 is NO, then the method branches back to step 88, where the deactivated plurality of switches continue to be latched OFF. If the answer is YES, then the method branches to step 82.

Description of apparatus 10b. With continued reference to FIG. 7, the control system 124 can be implemented using a microprocessor having outputs electrically connected to the gates of the switches 132 in the DC fast charger 10b. The control system 124, in an embodiment, includes a phase locked loop 144 electrically connected to the three legs PHA, PHB, PHC of the grid 112. The phase locked loop 144 can be used to determine the phase (θ_{grid}) of the AC voltage received from the grid 112. The phase can then be provided to a dq transformation block 146 to obtain a rotating reference frame (d_{q}) signal. A voltage controller 148 can generate I_{q}* using a target DC voltage level subtracted from a measured DC voltage level (V_{dc}*-V_{dc}). I_{q}* can be provided to a first current controller 150 along with d_{q} to generate V_{q}*. I_{d}* can be provided to a second current controller 152 along with d_{q} to generate V_{d}*. A dq-abc block 154 can receive Vq*, Vd*, and the phase (θ_{grid}), minus an angular offset, to a voltage source inverter (VSI) space vector modulation (SVM) block 156. The VSI SVM block 156 can provide output to a current source inverter (CSI) SVM block 158, which can provide output to a matrix SVM block 160. Gate signals can be generated at block 162 and electrically communicated to the gates of the switches 132 to control the conductive state.

The apparatus 10b can control the primary circuit 12b to induce the flow of AC current in the transformer 130. The change in the conductivity of the switches 132 included in the primary circuit 12b are set forth below.

An initial switch state of the primary circuit 12b involves a condition where the A and B MOSFETs of switches 132a and 132d are initially conductive to flow current through legs A and B, while the other switches are in a non-conductive state.

A first switching step can render the A side MOSFETs of switches 132a and 132d non-conductive.

A second switching step can render the B side MOSFET of the seventh switch 132g conductive.

A third switching step can render the B side MOSFET of switch 132a non-conductive, the B side MOSFET of switch 132c conductive, and the B side MOSFET of switch 132d non-conductive. The B side MOSFET of switch 132b is also rendered conductive. The conductive state change of switches 32a, 32c, and 32d can be considered soft switching events as they are made absent the presence of electrical current.

A fourth switching state can render the B side mosfet of switch 132g non-conductive.

A fifth switching state can render the A side MOSFET of switch 132c conductive and the A side of switch 132b conductive. The control system 124 can then return the conductive state of the primary circuit 12b to the initial switch state and repeat the five switching states to change the frequency of the AC voltage received from the grid 112.

It is to be understood that the foregoing is a description of one or more embodiments of the invention. The invention is not limited to the particular embodiment(s) disclosed herein, but rather is defined solely by the claims below. For example, in embodiment(s), the switch protection systems and methods described herein may be used as an alternative to or for cooperation with discrete components such as transient suppression devices, surge protection devices or varistors. As further example, the switch protection systems and methods described herein may be used in connection with a power conversion apparatus of the type suitable for use with and/or in a DC microgrid arrangement, such that the power conversion apparatus comprises an input stage having an input configured to be connected to receive an direct current (DC) voltage. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A power conversion apparatus, comprising:
an input stage having an input configured to be connected to receive an alternating current (AC) voltage, the input stage including a plurality of switches electrically coupled to the input and arranged in accordance with a power conversion topology;
a sensing circuit coupled to a monitored node in the input stage and configured to assert a disable signal when a sensed voltage level, corresponding to a node voltage level at the monitored node, exceeds a selectable threshold voltage level indicative of an overvoltage condition, the sensing circuit including a latch configured to maintain assertion of the disable signal until a release event occurs; and
an electronic controller configured to control the plurality of switches into conductive and non-conductive states for power conversion in accordance with a predetermined power conversion strategy, the controller being further configured to control the plurality of switches into respective non-conductive states in response to and while the disable signal is asserted.

2. The power conversion apparatus of claim 1, further comprising an output stage comprising a CLLC resonant converter configured to generate a direct current (DC) voltage on an output thereof, and wherein the input stage comprises a totem pole bridgeless power factor correction (PFC) stage.

3. The power conversion apparatus of claim 2 wherein the plurality of switches comprises first and second pairs of switches in the input stage and third and fourth pairs of switches in the output stage, wherein the controller, in response to and while the disable signal is asserted, controls the first, second, third, and fourth pairs of switches into non-conductive states.

4. The power conversion apparatus of claim 3 wherein the monitored node comprises a DC bus coupled between the input stage and the output stage.

5. The power conversion apparatus of claim 1, further comprising an output stage configured to generate a direct current (DC) voltage on an output thereof, wherein the input and output stages are coupled by a transformer, and wherein the input stage comprises an AC/AC indirect matrix converter configured to convert input three-phase AC electric power to single-phase AC electric power.

6. The power conversion apparatus of claim 5, wherein the plurality of switches comprises first, second, and third pairs of switches, the first pair including first and second switches series-connected at a first connecting node, the second pair including third and fourth switches series-connected at a second connecting node, the third pair including fifth and sixth switches series-connected at a third connecting node wherein the first, second, and third connecting nodes are respectively coupled to first, second, and third phases of the input three-phase AC electric power, wherein the controller, in response to and while the disable signal is asserted, controls the first, second, third, fourth, fifth, and sixth switches into respective non-conductive states.

7. The power conversion apparatus of claim 6, wherein the indirect matrix converter further comprises a seventh switch electrically connected in parallel with the first, second, and third pairs of switches, the indirect matrix converter further including a shim inductor series-connected with a primary winding of the transformer wherein the seventh switch is connected in parallel with the inductor and primary winding;
wherein the controller, while the disable signal is de-asserted, controls the seventh switch along with the first, second, third, fourth, fifth, and sixth switches into conductive and non-conductive states for power conversion in accordance with the predetermined power conversion strategy;
wherein the controller, in response to and while the disable signal is asserted, controls the seventh switch into the conductive state to thereby dissipate electrical current circulating in the inductor and primary winding.

8. The power conversion apparatus of claim 1, wherein the node is a monitored node, and the sensing circuit includes a resistive voltage divider coupled between the monitored node and a ground node where the voltage divider is configured to produce a sensed signal having the sensed voltage level.

9. The power conversion apparatus of claim 8, wherein the sensing circuit includes a comparator that includes (i) an inverting input coupled to receive the sensed signal, (ii) a non-inverting input configured to receive a threshold signal having a threshold voltage level, and (iii) an output configured to produce the asserted disable signal when the sensed voltage level exceeds the threshold voltage level.

10. The power conversion apparatus of claim 9 further comprising a digital-to-analog converter (DAC) configured to generate the threshold signal based on a selectable digital input corresponding thereto.

11. The power conversion apparatus of claim 9 further comprising an analog circuit configured to generate the threshold signal in accordance with predetermined criteria.

12. The power conversion apparatus of claim 9 wherein the latch includes feedback circuitry that is electrically coupled between the comparator output and the comparator inverting input.

13. The power conversion apparatus of claim 1 wherein the controller is configured to determine when the overvoltage condition has ended corresponding to the release event, wherein the controller is configured to reset the comparator so that the disable signal is de-asserted.

14. The power conversion apparatus of claim 1 where the release event corresponds to a predetermined time after onset of the overvoltage condition, said apparatus further including a timer configured to reset the comparator, after the predetermined time has elapsed, so that the disable signal is de-asserted.

15. A method of protecting switches in a power conversion apparatus from an overvoltage event, comprising:
controlling a plurality of switches in an input stage of the power conversion apparatus into conductive and non-conductive states for power conversion according to a predetermined power conversion strategy;
sensing at least one voltage level corresponding to a node voltage level on at least one node in the input stage;
determining when the sensed at least one voltage level exceeds a threshold voltage level indicative of an overvoltage condition on the at least one node and asserting a disable signal;
rendering the plurality of switches into non-conductive states in response to and while the disable signal is asserted.

16. The method of claim 15, further comprising:
adjusting the threshold voltage level according to adjustment criteria.

17. The method of claim 15, further comprising:
latching the plurality of switches non-conductive by continued assertion of the disable signal until a release event occurs;
determining when the release event has occurred and discontinuing assertion of the disable signal.

18. The method of claim 16, wherein determining when the release event has occurred further comprises one of determining when the overvoltage condition has ended and determining when a predetermined time after the onset of the overvoltage condition has elapsed.

19. The method of claim 15, further comprising:
providing a further switch in the input stage of the power conversion apparatus that is electrically connected in parallel with the plurality of switches and is electrically connected in parallel a shim inductor that is series-connected with a primary winding of a transformer that inductively couples the input stage to an output stage;
rendering the further switch into the conductive state in response to and while the disable signal is asserted, to thereby dissipate electrical current circulating in the inductor and primary winding.

20. A power conversion apparatus, comprising:
an input stage having an input configured to be connected to receive an direct current (DC) voltage, the input stage including a plurality of switches electrically coupled to the input and arranged in accordance with a power conversion topology;
a sensing circuit coupled to a monitored node in the input stage and configured to assert a disable signal when a sensed voltage level, corresponding to a node voltage level at the monitored node, exceeds a selectable threshold voltage level indicative of an overvoltage condition, the sensing circuit including a latch configured to maintain assertion of the disable signal until a release event occurs; and
an electronic controller configured to control the plurality of switches into conductive and non-conductive states for power conversion in accordance with a predetermined power conversion strategy, the controller being further configured to control the plurality of switches into respective non-conductive states in response to and while the disable signal is asserted.
